(19) United States
(12) Patent Application Publication
(10) Pub. No.: US 2015/0204803 A1
(43) Pub. Date: Jul. 23, 2015

(54) DETERMINING ELEMENTAL CONCENTRATION USING COMPTON SCATTERING

(71) Applicants: Northeastern University, Boston, MA (US); Japan Synchrotron Radiation Research Institute, Hyogo (JP); Gunma University, Maebashi City (JP)

(72) Inventors: Arun Bansil, Dover, MA (US); Bernardo Barbiellini, Brookline, MA (US); Yoshiharu Sakurai, Himeji-shi (JP); Masayoshi Itou, Aioi-shi (JP); Hiroshi Sakurai, Maebashi City (JP); Kosuke Suzuki, Maebashi-shi (JP)

(21) Appl. No.: 14/462,109

(22) Filed: Aug. 18, 2014

Related U.S. Application Data
(60) Provisional application No. 61/930,675, filed on Jan. 23, 2014.

(51) Int. Cl. G01N 23/20

(52) U.S. Cl. CPC G01N 23/20066

(57) ABSTRACT

The present application relates to methods of determining a concentration of an element, such as lithium, using analysis of a Compton scattering spectrum's lineshape.

### CROSS-REFERENCE TO RELATED PATENT APPLICATIONS

The present application claims priority to U.S. Provisional Application No. 61/930,675 filed Jan. 23, 2014, which is incorporated by reference in its entirety.

### STATEMENT OF GOVERNMENT SUPPORT

This invention was made with US government support under the US Department of Energy, Office of Science, Basic Energy Sciences contract number DE-FG02-07ER46352 and the US Department of Energy grant number DE-AC02-05CH11231. The US government may have certain rights in the invention. This invention was also made with Japan government support by the Development of Systems and Technology for Advanced Measurement and Analysis program under Japan Science and Technology Agency. The Japan Synchrotron Radiation Research Institute and Gunma University may have certain rights in the invention.

### FIELD

The present application relates in general to analytical techniques for determining elemental concentrations and, in particular, to methods of determining a concentration of a metallic element using Compton scattering.

### SUMMARY

One embodiment is a method of determining an elemental concentration, comprising (a) obtaining a sample comprising a chemical element; (b) measuring a Compton scattering spectrum of the sample; and (c) analyzing a lineshape of the measured spectrum to determine a concentration of the element in the sample.

In some embodiments, the chemical element may be a metal element, which may be, for example, an alkali metal or an alkaline earth metal.

In some embodiments, the metal element may be Li. In such a case, in certain embodiments the sample may comprise a lithiated transition metal oxide. In certain embodiments, the sample may comprise at least one of LiₓMn₂O₄; LiₓCoO₂; LiₓMnO₂; LiₓPO₄; LiₓNiO₂; LiₓTi₅O₁₂; LiₓFeSiO₄; LiₓNiₐCo_{b}Al_{c}O₂ and LiₓNiₐMn_{b}Co_{c}O₂ where each of a, b and c is a non-negative number, such that a+b+c=1. In such a case, the analysis of the lineshape may determine x.

In some embodiments, the sample may be a solid sample. In certain cases, the solid sample may be a polycrystalline sample.

In some embodiments, the sample may be a liquid sample.

In some embodiments, the sample may be a graphite intercalation compound or a silicon compound.

In some embodiments, the lineshape's analysis may involve determining a central-to-tail parameter in the measured spectrum, from which parameter the concentration of the chemical element may be determined. In such a case, in certain embodiments, the determination of the concentration may involve using a calibration curve establishing a relationship between the concentration of the element and the central-to-peak parameter in the measured spectrum. Such calibrating curve may be obtained by measuring a Compton scattering spectrum of one or more calibrating samples having a known concentration of the chemical element and determining a central-to-tail parameter value in the Compton scattering spectrum of the one or more calibrating samples.

In some embodiments, the lineshape's analysis may involve presenting the measured Compton scattering spectrum as a Compton profile with an intensity in inverse atomic units versus momentum in atomic units. In such a case, the lineshape's analysis may further involve determining a ratio between a central area under the Compton profile to a tail area under the Compton profile. In certain cases, the central area may be an area under the normalized Compton profile for values of the momentum ranging from 0 to a boundary value, while the tail area may be an area under the Compton profile for values of the momentum ranging from the boundary value to infinity. The boundary momentum may be, for example, between 2 atomic units and 8 atomic units.

In some embodiments, the Compton scattering measurement may be performed using incident X-rays with energy greater than 50 keV and lower than 1.022 meV.

In some embodiments, the sample may be inside a container which is non-penetrable by photoelectrons. In such a case, the Compton scattering measurement may be performed while the sample is inside the container. The sample inside the container may be a part of an electronic or electrochemical device, such as a battery.

### BRIEF DESCRIPTION OF THE FIGURES

The patent or application file contains at least one drawing executed in color. Copies of this patent or patent application publication with color drawing(s) will be provided by the Office upon request and payment of necessary fee.

FIG. 1 schematically depicts an apparatus for Compton scattering.

FIG. 2 presents Compton scattering peaks for LiₓMn₂O₄ with various lithium concentration x.

FIG. 3 presents illustrates evaluation of the R-parameter.

FIG. 4 presents a calibration line for evaluating lithium concentrations from the R-parameter.

FIG. 5 presents Energy Spectra of Compton scattered X-rays of polycrystalline LiₓMn₂O₄ (x=0.5, 1.1 and 2.0). Blue, red and green dots correspond to energy spectra of Li_{0.5}Mn₂O₄, Li_{1.1}Mn₂O₄ and Li_{2.0}Mn₂O₄, respectively.

FIGS. 6(a) and (b) present respectively: (a) Compton profiles of Li atom (red line), Mn atom (blue line) and O atom (green line) calculated by the Hartree-Fock calculation. A Compton profile for LiMn₂O₄ (orange line) is given by a weighted sum of Li, Mn and O atoms. (b) Valence-electron Compton profiles of Mn atom (purple line) and O atom (green line).

FIG. 7 shows experimental S-parameters (red solid circles) for LiₓMn₂O₄, together theoretical ones by atomic model calculations (blue solid triangles) and KKR-CPA calculations (green solid squares). The dotted line shows calibration curve for lithium composition, x. The S-parameters show the linear relationship the lithium composition. For experimental data, the lithium composition was determined by ICP measurements.

FIG. 8 illustrates a relationship between the statistical errors of S-parameters and the integrated photon numbers of Compton scattered X-rays for d=4 (green dotted line), 6 (red dotted line) and 7 (blue dotted line).

### DETAILED DESCRIPTION

Unless otherwise specified, “a” or “an” means “one or more.”

The terms “S-parameter,” “R-parameter” and “central-to-tail parameter” may have the same or similar meaning in this document.

The term “element” and its derivatives such as “elemental” refer to a chemical element in its atomic and/or ionic forms.

The present technology provides a method for determining an elemental concentration by analyzing a lineshape of a Compton scattering spectrum.

The method may be used for determining an unknown concentration of an element, which contributes to a Compton scattering spectrum. In some embodiments, such an element may be a metal element. For example, the metal element may be an alkali metal, such as Li, Na, K, Cs, Rb, or Fr, or an alkaline earth element, such as Be, Mg, Ca, Sr, Ba, or Ra.

Considering that the Compton scattering strength depends on a number of total electrons in a particular element, the present method may be more sensitive for an element having a greater number of total electrons. For example, the present method may be more sensitive for determining a concentration of sodium (Z=11) or magnesium (Z=12) than for determining a concentration of lithium because sodium and magnesium ions have more electrons than lithium (Z=3) ions.

The present method utilizes direct or indirect comparison of a lineshape of a Compton scattering spectrum for a sample with an unknown concentration of an element with a Compton scattering spectrum lineshape of the otherwise identical sample, for which a concentration of the element in question is known. Preferably, the method involves comparison of a Compton scattering spectrum lineshape for a sample with an unknown concentration of an element with Compton scattering spectrum lineshapes of multiple otherwise identical samples with various known concentrations of the element in question. The present method may be used for determining an unknown concentration of an element in a variety of materials.

In some embodiments, the present method may be used for determining an unknown concentration of Li. For example, the present methods may be used for determining a lithium concentration in a lithiated transition metal oxide. Such materials are used, for example, for making an electrode in an electrochemical device, such as a battery. The use of the electrochemical device may change a lithium concentration in an electrode made from the lithiated transition metal oxide. Thus, the present methods may allow determining the lithium concentration after such change. Examples of lithiated transition metal oxides, include, but are not limited e.g., to LiₓMn₂O₄; LiₓCoO₂; LiₓMnO₂; LiₓFePO4; LiₓNiO₂; LiₓTi₅O₁₂; LiₓFeSiO₄; LiₓNiₐCo_{b}Al_{c}O₂ and LiₓNiₐMn_{b}Co_{c}O₂. For the last two formulas, each of a, b and c is a non-negative number, such as a+b+c=1. One non-limiting example of LiₓNiₐCo_{b}Al_{c}O₂ may be LiₓNi_{0.8}Co_{0.15}Al_{0.05}O₂, while one non-limiting example of LiₓNiₐMn_{b}Co_{c}O₂ may be LiₓNi_{1/3}Mn_{1/3}Co_{1/3}O₂. For the lithiated transition metal oxides exemplified above determining a concentration of lithium may involve determining x.

In some embodiments, determining a concentration of an element from a Compton scattering spectrum lineshape may comprise determining a central-to-tail parameter in the Compton spectrum, from which parameter the elemental concentration may be determined Such central-to-tail parameter may be a parameter comparing a central portion of the Compton scattering spectrum with its peripheral (tail) portion(s). For example, the central-to-tail parameter may be a ratio between an area under the central portion of the Compton scattering spectrum and an area under the peripheral portions of the Compton scattering spectrum. The elemental concentration in the studied sample may be determined from the determined value of the central-to-tail parameter by using a calibration relationship, which may be, for example, represented a calibration curve or graph, established between a concentration of the element in question and the central-to-tail parameter. Such calibration relationship may be obtained by measuring Compton scattering spectra of one or more calibrating samples, which are otherwise identical to the studied sample, but have a known concentration of the element in question, and determining values of the central to tail parameter in such spectra.

In some embodiments, to analyze the measured Compton scattering spectrum, it may be converted to a Compton profile, the momentum (x-axis) may be represented in atomic units. Methods of such conversion are known to those skilled in the art, see e.g., formula (4) in the Example below. In some embodiments, the Compton profile may be such that its y-axis presents intensity in inverse atomic units. The conversion to the Compton profile may involve a subtraction of the core electron contribution to Compton scattering. The conversion may further involve normalizing the Compton profile to a particular value. In some embodiments, it may be preferred to normalize a Compton profile to the same value, to which Compton profiles used to obtain a calibration curve were normalized. The Compton profile may be also corrected for one or more of the following: absorption X-rays in a sample, analyzer and detector efficiencies; scattering cross section of X-rays possible double scattering contributions and X-ray background. Such corrections are known to those skilled in the art, see e.g., Chapter 5 in “X-ray Compton scattering” eds. M. J. Cooper et al., Oxford University Press, 2014.

A Compton profile may be used for determining a central-to-tail ratio, which is a ratio between a central area under the Compton profile and a peripheral area under the normalized profile. The central area and the peripheral area may be separated by a boundary momentum value. In some embodiments, the boundary momentum value may be a momentum value, which is arbitrarily selected away from the center of the Compton profile such that the intensity corresponding to such value is substantially non-zero: for example, from 2 to 8 atomic units the calibration relationship between a concentration of the element in question and the central-to-tail parameter may be well-defined, and the error in the calibration relationship may be optimized. Yet in some embodiments, a boundary momentum value may be determined using theoretical modeling, such as Hartree-Fock calculations, and/or studying materials with a known composition. The boundary momentum value may be selected to be such that a contribution from the element in question is negligible in a tail area(s) of the Compton profile compared to a contribution from the same element in a central area of the Compton profile. For example, the contribution from the element in question in the tail area(s) of the Compton profile may be at least 3 times or at least 5 times or at least 10 times or at least 20 times or at least 50 times or at least 100 times smaller than the contribution from the same element in the central area of the Compton profile. Overall, a boundary momentum value may depend on a composition of a studied material and on a particular element, which concentration is desired to be determined in the studied material. For determining a lithium concentration from Compton profiles for lithiated transition metal oxides, such as LiₓMn₂O₄, a boundary momentum value may be, for example, from 2 to 8 atomic units.

For determining the central-to-tail ratio, the central area may be an area under the Compton profile for values of the momentum from 0 to the boundary value and the tail area may be an area under the Compton profile for values of the momentum from the boundary value to infinity. Alternatively, the central area may be an area under the Compton profile for values of the momentum from the minus boundary value to the (plus) boundary value and the tail area may be a sum of the following two areas under the Compton profile: a) an area for momentum values from minus infinity to the minus boundary value and b) an area for momentum values from the (plus) boundary value to infinity. The determination of central and tails areas as well as the determination a central-to-peak ratio for a Compton profile may be performed using an appropriate program on a computing device, such as a personal computer. For practical purposes, instead of infinity in the above definitions, one can use a finite momentum value, for which Compton intensity is not affected by changes in a concentration of an element in question. For example, for determining Li concentration in LiₓMn₂O₄, such finite momentum value replacing the infinity in the above definitions may be 10 or greater.

Measuring Compton scattering spectrum may be performed using an X-ray spectrometer. The energy of incident X-rays may range, for example, from 50 keV to 1,022 MeV or from 100 keV to 1,022 MeV or from 50 keV to 500 keV. The X-ray scattering measurement may be performed at a fixed scattering angle, which may be for example, from 45° to 178° or any value or subrange within this range.

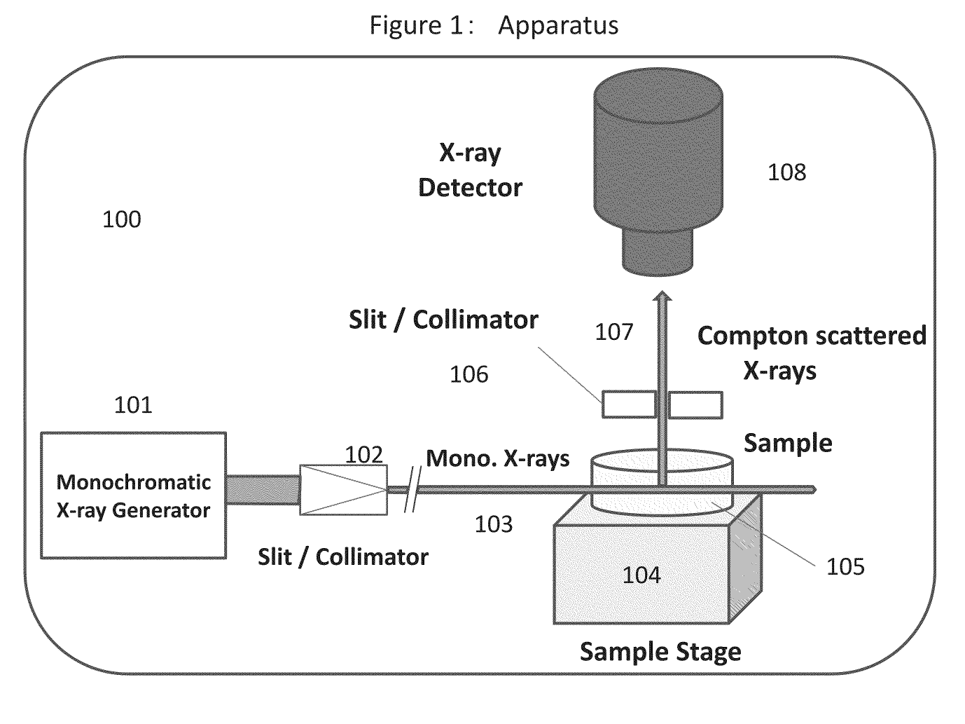

FIG. 1 schematically illustrates an apparatus which may be used for measuring Compton scattering spectrum. The apparatus may include a source of X-rays 101, which may be a monochromatic X-ray Generator, a set of slits and/or a collimator 102, which may be used to define the size of incident X-rays 103, a sample stage 104 configured to hold a sample 105, in which a concentration of an element in question, has to be determined; a set of slits and/or a collimator 106 for scattered rays 107, i.e. X-rays scattered from the sample 105, and an X-ray detector 108 for detecting the scattered X-rays 107. Although FIG. 1 shows that an angle between the incident X-rays 103 and the scattered X-rays 107 is 90°, an angle between incident X-rays and scattered X-rays in an actual experiment may differ from 90°.

The present methods may be used for non-destructive determining a concentration of an element in a sample that may be inside of a container, without removing the sample from the container, as long as the container may be penetrated by X-rays. In some embodiments, the container may be non-penetrable for photoelectrons, which means that the sample inside of the container cannot be studied using photoelectron techniques, such as X-ray photoelectron spectroscopy. In some embodiments, the sample inside of a container may be a part of an electronic or electrochemical device, such as a battery. The present methods may allow determining an elemental concentration of a component of such devices, such as an electrode and/or an electrolyte, in situ and/or operando. The present methods are not particularly limited by a size of a device or its component. As such, the present methods may be applied for determining an elemental concentration in smaller devices and their components, such as batteries for consumer electronics, including smartphones, tablets and laptops, as well as in larger devices and their components, such as batteries in motor vehicles, such as motorcycles, personal automobiles, buses and trucks.

In some embodiments, the present methods may be used for determining an elemental concentration in a component of a device, which concentration changes during the operation of the device. For example, during an operation of an electrochemical device, such as a battery, a concentration of certain element(s) may change in the device's component(s), such as electrode(s) and/or electrolyte due to ion exchange between them. One example of such electrochemical device may be a lithium ion battery. During discharging of such battery, lithium ions move from the negative electrode to the positive electrode and in the opposite direction, i.e. from the positive electrode to the negative electrode, during the battery's charging. The present methods may be used for determining a lithium concentration in one or more component a lithium ion battery, such a positive, a negative electrode and electrolyte. Examples of materials, which may form positive electrodes in lithium ion batteries, include, but is not limited to, e.g., LiₓMn₂O₄; LiₓCoO₂; LiₓMnO₂; LixFePO4; LiₓNiO₂; LiₓFeSiO₄; LiₓNiₐCo_{b}Al_{c}O₂ and LiₓNiₐMn_{b}Co_{c}O₂. For the last two formulas, each of a, b and c is a non-negative number, such as a+b+c=1. x in the above formulas is the concentration of lithium, which may be determined using the present methods. In general, x is a non-negative number, with x being 0 corresponding to the situation when no lithium is present.

Example of materials, which may form negative electrodes in lithium ion batteries, include, but not limited to, graphite compounds, such as graphite intercalation compounds, which may have, for example, formulas LiₓC₈ or LiₓC₆; lithium titanate (LiₓTi₅O₁₂); silicon; carbon; silicon/carbon; tin/cobalt. The present methods may be used for determining lithium ion concentration, such as x in the above formulas, in a negative electrode.

Electrolyte used in a lithium ion battery may be a liquid or solid electrolyte. Examples of liquid electrolytes include solutions of a lithium containing compound, such as a lithium salt, which may be for example, LiₓPF₆, LiₓBF₄, LiₓClO₄, LixAsF₆; LiₓH₂PO₄; LiₓAlCl₄; LiₓGaAl₄; CF₃SO₃Liₓ; LiₓB(C₂O₄)₂; C₂BF₂LiₓO₄, in one or more solvents, which may be, for example, an organic solvent, such as ethylene carbonate, dimethyl carbonate and diethyl carbonate. Solid electrolytes may be, for example, La_{0.51}Li_{0.34+x}TiO_{2.94}, Li_{1.3+x}Al_{0.3}Ti_{1.7}(PO₄)₃, Li₇₊ₓLa₃Zr₂O₁₂, 50Li₄₊ₓSiO₄*50Li_{3+y}BO₃, Li_{2.9+x}PO_{3.3}N_{0.46}(LIPON), Li_{1.07+x}Al_{0.69}Ti_{1.46}(PO₄)₃, Li_{1.5+x}Al_{0.5}Ge_{1.5}(PO₄)₃, Li_{3.25+x}Ge_{0.25}P_{0.75}S₄, Li₁₀₊ₓGeP₂S₁₂, Li₆₊ₓPS₅Cl, 30Li₂₊ₓS*26B₂S₃*44Li_{1+y}I, 63Li₂₊ₓS*36SiS₂*1Li_{3+y}PO₄, 57Li₂₊ₓS*38SiS₂*5Li_{4+y}SiO₄, Li_{3.25+x}P_{0.95}S₄, Li₇₊ₓP₃S₁₁).

The present methods may be used for determining lithium ion concentration, such as x and y in the above formulas, in the electrolyte.

The present methods may be used for determining ion concentration in other electrochemical devices. For example, the present methods may be used for determining a concentration of mobile ions, such as H⁺, O²⁻ and CO₃²⁻ in an electrolyte used in an electrochemical device. The principle for measuring such mobile ions may be the same as for discussed in greater details measuring of Li⁺ ion taking into account that Li⁺ ion is accompanied by 3 electrons, while H⁺ accompanies 1 electron, O₂⁻ does 16 electrons, CO₃²⁻ does 30 electrons. Embodiments described herein are further illustrated by, though in no way limited to, the following working examples.

### Working Example

### This Section Uses “S-Parameter” Instead of “R-Parameter”

Based on an X-ray Compton scattering experiment on polycrystalline LiₓMn₂O₄, it was found that the line-shape of Compton scattered X-rays is sensitive to the lithium composition. In order to characterize the line-shape, a parameter S is introduced. The experimental S-parameter has a linear relationship with the lithium concentration, and both atomic models and band structure calculations reproduce this trend. The present result shows that the line-shape analysis with S-parameter can be used to measure the lithium concentration in battery electrodes. The proposed line-shape method overcomes the difficulty of the Compton scattering intensity method, where the analysis is affected by the X-ray absorption in the samples. Thus the proposed method is also applicable to large lithium-ion rechargeable batteries under in-situ and operando conditions because X-rays with high energy greater than 100 keV are used.

The development of experimental techniques to monitor and analyze electrochemical processes under in-situ and operando conditions is crucial for the optimization of higher performance lithium-ion batteries. Several techniques, such as X-ray absorption near-edge structure (XANES),¹ (for citations corresponding to superscripts, see section REFERENCES below) nuclear magnetic resonance (NMR),² X-ray diffraction³ and neutron diffraction,⁴⁻⁸ have been developed for visualizing the chemical changes that take place in batteries. Because of short probing depth or low spatial resolution, however, the application of these techniques is limited to test cells or small-size batteries. A new non-destructive probe with both high penetrating power and high spatial resolution is needed for assessing the performance of large-size batteries such as those mounted on electric vehicles. Compton scattering densitometry⁹ and imaging^{10,11} with high-energy X-rays is one of the promising non-destructive techniques, since both the X-ray penetration depth and the effective Compton scattering intensity increase as the X-ray energy increases. The intensity of Compton scattered X-rays is linearly proportional to the electron density of the scattering volume, and this feature enables us to characterize the materials. In addition, it is possible to image the internal structure of an object by scanning the X-ray beams. Recently, a Compton scattering imaging technique with high-energy synchrotron X-rays has been applied to a coin cell, and the internal structure and the chemical reaction in the positive electrode have been successfully visualized.¹² However, there is a drawback associated with this technique since the scattering intensity depends on X-ray absorption along the beam path inside the object. This problem worsens as the object becomes larger. Therefore, when this technique is applied to a large battery, one cannot easily detect the change in Compton scattered X-ray intensity produced by the variation of lithium composition in an electrode during the charge and discharge cycles.

In order to overcome this difficulty, the present example focuses on analyzing the line-shape of Compton scattered X-rays, the so-called Compton profile, which is determined by the electron momentum density distribution. Within the impulse approximation,^{13,14} the double differential cross section is given as a simple form,

$$\frac{{d}^{2} σ}{d Ω {dE}_{2}} = F \cdot J ( {p}_{z} ) , \qquad ( 1 )$$

where the explicit form of the function F is given by Ribberfors.¹⁵ Therefore, the double differential cross section is proportional to Compton Profile J(p_{z}). The Compton profile is given in terms of ground-state electron momentum density ρ(p) by the formula

J(p_{z})=∫∫ρ(p)dpₓdp_{y} (2)

where p=(pₓ, p_{y}, p_{z}) is electron momentum and p_{z} is taken to lie along the direction of the scattering vector. The momentum density can be expressed as^{16,17}

ρ(p)=Σⱼnⱼ|∫Ψⱼ(r)exp(−ip·r)dr|² (3)

where, Ψj(r) is the wave function of electron in the j-state and nⱼ the electron occupation of j-state. The index j runs over all constituent atoms and orbitals. Therefore the line-shape of Compton profile is sensitive to constituent atoms and orbitals.

So far X-ray Compton scattering has been used for various studies in solid states physics and materials science.¹⁸⁻²¹

This example introduces a parameter S to quantify the line-shape of Compton scattered X-rays and demonstrate that experimental and theoretical S-parameters of LiₓMn₂O₄ are proportional to the lithium concentration x. This result shows that the line-shape analysis with the S-parameter is applicable to monitor the lithium concentration of battery electrodes under in-situ and operand conditions.

The Compton scattering experiment was carried out with the Cauchois-type X-ray spectrometer at BL08W in SPring-8, Japan.^{22,23} The energy of incident X-rays was 115 keV and the scattering angle was fixed at 165 degrees. The overall momentum resolution was 0.1 atomic units (a.u.). The measurements were performed under vacuum and room temperature. Polycrystalline LiₓMn₂O₄ (x=0.5, 1.1, 1.2, 1.8, 1.9, 2.0, 2.1 and 3.3) samples were prepared by extracting/inserting lithium chemically. The lithium compositions were measured by the inductively coupled plasma (ICP) measurement. X-ray powder diffraction confirms a single spinel structure for x=0.5-1.2 and co-existence of spinel and tetragonal structure for 1.2<x 3.3. The size of samples is 10 mm in diameter and 2 mm in thickness.

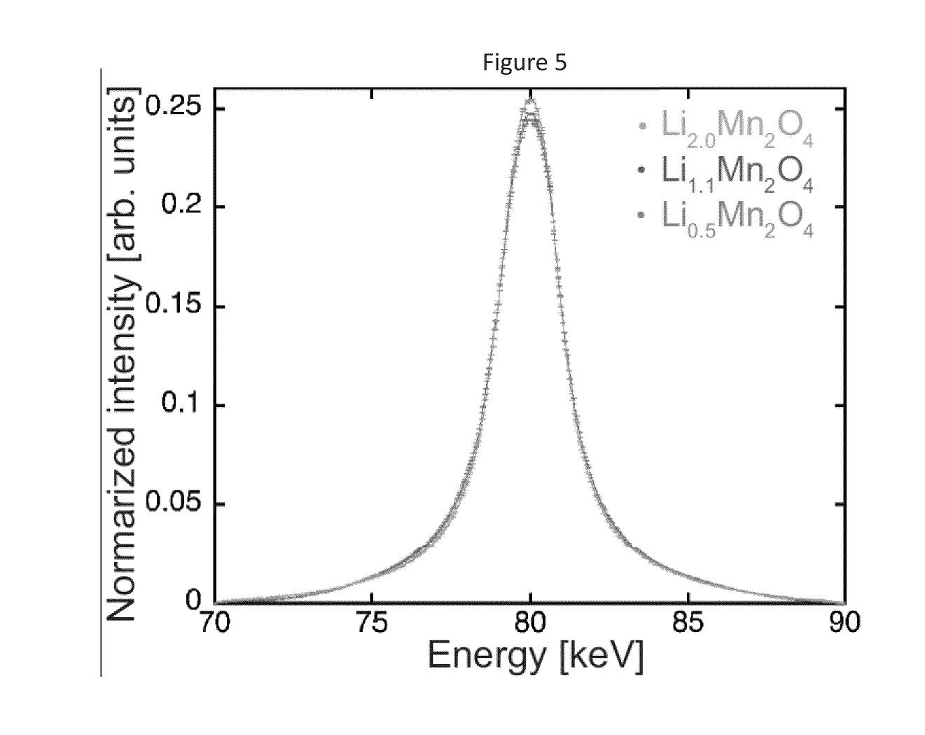

FIG. 5 shows the energy spectra of Compton scattered X-rays of LiₓMn₂O₄ with x=0.5, 1.1 and 2.0. The area under the spectra is normalized to same value. The peak height at 80 keV increases with increasing the Li composition, indicating that X-ray Compton scattering is sensitive to the Li composition. The spectra at energies lower 75 keV and higher than 85 keV do not seem to depend on the Li composition. The X-ray energy is converted into electron momentum, p_{z}, by the following equation¹³

Here E₁ and E₂ denote incident and Compton scattered X-rays energies, m is the electron mass, c the light velocity and θ the

scattering angle. In FIG. 5, 80 keV, 75 keV and 85 keV correspond to 0 a.u., −6 a.u. and 6 a.u., respectively. After the cross-section corrections for X-ray absorption and multiple scattering, the Compton profile of eq. (2) can be obtained by the energy-to-momentum conversion given by eq. (4).

$$\frac{{p}_{z}}{mc} ≅ \frac{{E}_{2} - {E}_{1} + ( {E}_{2} {E}_{1} / {mc}^{2} ) ( 1 - cos θ )}{\sqrt{{E}_{1}^{2} + {E}_{2}^{2} - 2 {E}_{1} {E}_{2} cos θ}} \qquad ( 4 )$$

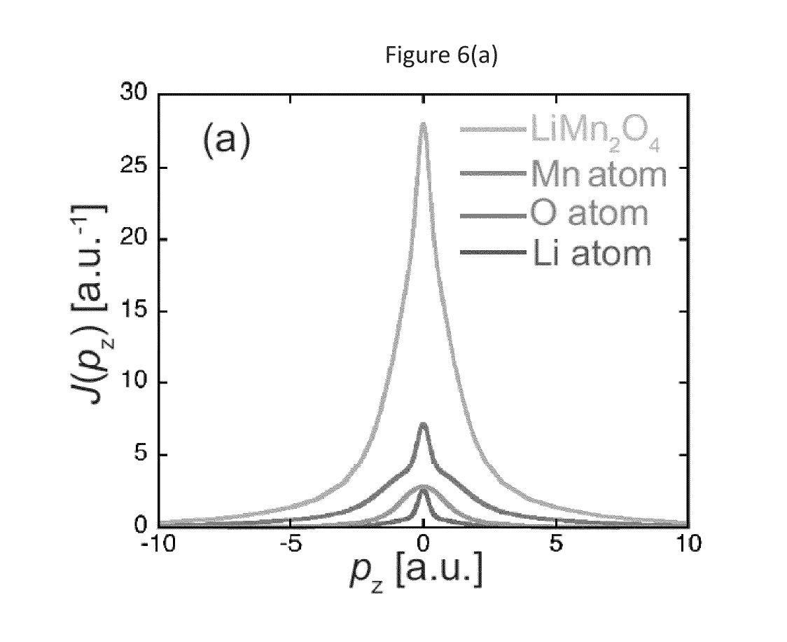

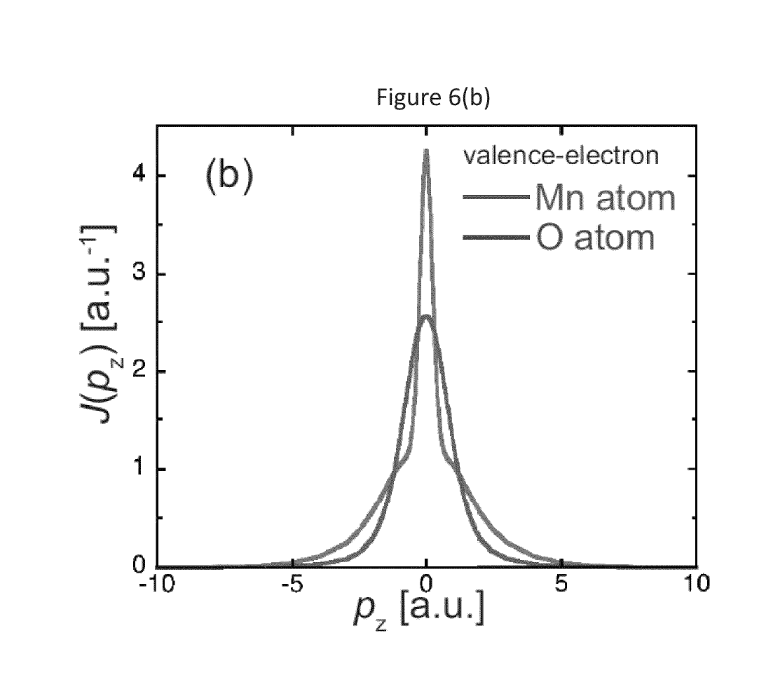

We have simulated the lines-shape of Compton scattered X-rays with the Hartree-Fock Compton profiles calculated for each element.²⁴ FIG. 6(a) shows the Compton profiles of Li atom (J_{Li}), Mn atom (J_{Mn}), O atom (J_{O}) and LiMn₂O₄ (J_{LMO}). The profile of LiMn₂O₄ (J_{LMO}) is given as a sum of the Li, Mn, O profiles weighted by the compositions. Here, both valence and core electrons are included. FIG. 6(b) shows the valence electron contributions, J^{val}_{Mn} and J^{val}_{O}, for Mn and O atoms, where J^{val}_{Mn} includes 3d and 4s electrons, and J^{val}_{O} does 2s and 2p electrons. Among them the Li atom (J_{Li}) shows the narrowest distribution within |p_{z}|=2.5 a.u., while both J^{val}_{Mn} and J^{val}_{O} are extended up to |p_{z}|=6 a.u. The region higher than |p_{z}|=6 a.u. is dominated by the Mn core electrons. Therefore, the Compton profile of LiₓMn₂O₄ is sensitive to the lithium composition in the low momentum region with |p_{z}|<2.5 a.u. This observation supports the lithium composition dependence illustrated in FIG. 5.

S-parameter may be defined as follows,

$$\begin{matrix}S = \frac{{S}_{L}}{{S}_{H}} & ( 5 ) \\ {S}_{L} = {\int }_{- d}^{d} J ( {p}_{z} ) d {p}_{z} & ( 6 ) \\ {S}_{H} = {\int }_{- 10}^{- d} J ( {p}_{z} ) d {p}_{z} + {\int }_{d}^{d 10} J ( {p}_{z} ) d {p}_{z} & ( 7 )\end{matrix}$$

where S_{L} and S_{H} are the areas under the Compton profile at the low and high momentum regions, respectively. The parameter d denotes the boundary between the low and high regions. S_{L} and S_{H} can be decomposed into the contribution of each atom, i.e. S_{L}_{_{—}}_{Li} and S_{H}_{_{—}}_{Li}, S_{L}_{_{—}}_{O} and S_{H}_{_{—}}_{O}, or S_{L}_{_{—}}_{Mn} and S_{H}_{_{—}}_{Mn}. The S-parameter is given as

$$S = \frac{{S}_{L}}{{S}_{H}} = \frac{{xS}_{L\_Li} + 2 {S}_{L\_Mn} + 4 {S}_{L\_O}}{{xS}_{H \_Li} + 2 {S}_{H \_Mn} + 4 {S}_{H \_O}} \qquad ( 8 )$$

where the coefficients, x, 2 and 4, are the compositions of LiₓMn₂O₄. By choosing a value of d in eqs. (6) and (7) so that S_{H}_{_{—}}_{Li} is negligible, the S-parameter in eq. (8) becomes linearly proportional to the lithium composition, x. Although S_{H}_{_{—}}_{Li} is already negligible for d=2.5, the value of d=6 was chosen because the manganese and oxygen valence states with |p_{z}|=<6 a.u are modified by lithium insertion and extraction.

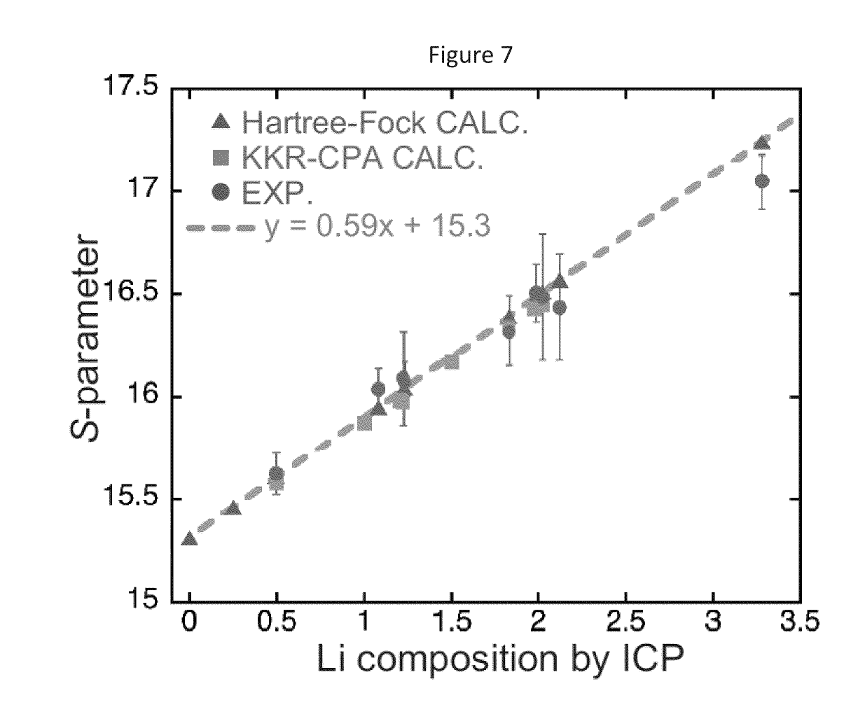

FIG. 7 shows the linear relationship of the experimental S-parameter with the lithium concentration x. In order to explain this trend, we have evaluated the S-parameters from theoretical Compton profiles for LiₓMn₂O₄ with x=0.5, 1.0, 1.2, 1.5, 1.8 and 2.0 by first-principles Korringa-Kohn-Rostoker coherent-potential-approximation (KKR-CPA) calculations within the framework of the local spin density approximation.^{25,26} The theoretical S-parameters of the KKR-CPA calculations, together with those of the Hartree-Fock atomic model, show a linear relationship with x, which agrees with the experimental trend. The linear expression can be fitted by

S=0.59x+15.3 (9)

which is used as the calibration curve.

ΔS=1.9×10³Iₛ^{-0.5} (10)

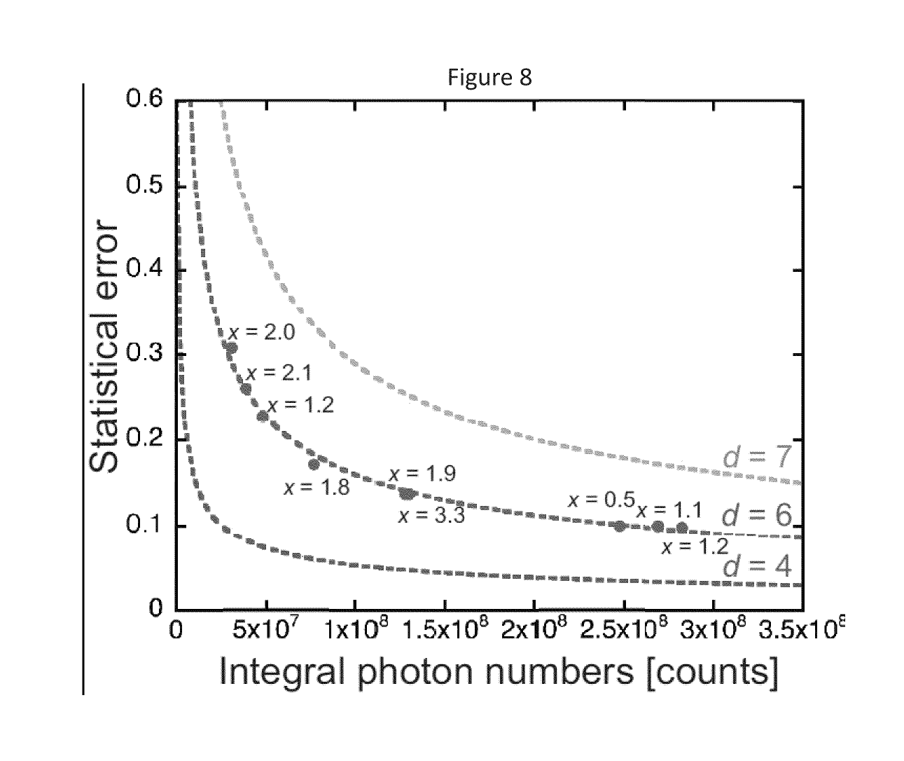

FIG. 8 shows the statistical errors of S-parameters as a function of the number of integrated photon counts Iₛ. For d=6, the errors, ΔS, are given by the following expression

The errors depend on the value of d. When a smaller d is chosen, the errors become small. In the case of LiₓMn₂O₄ the minimum d is 6 in order to maintain the linear relationship between S-parameters and lithium concentrations.

In summary, X-ray Compton scattering experiments on LiₓMn₂O₄ were carried out and it was demonstrated that the lineshape analysis of Compton scattered X-rays with S-parameters can be used to measure the lithium concentration in the positive electrode materials. This accurate method is applicable to large batteries such as those mounted on electric vehicles under in-situ and operando conditions, since high energy X-rays greater than 100 keV are used. This technique can also be extended to negative electrodes in batteries.

### REFERENCES

¹H. Arai, et al. J. Mater. Chem. 1, 10442 (2013).
²S. Chandrashekar, et al. Nature Mater. 11, 311 (2012).
³J. Liu, et al. J. Phys. Chem. Lett. 1, 2120 (2010).
⁴M. Lanz, et al., J. Power Sources 101, 177 (2001).
⁵D. Goers, et al., J. Power Sources 130, 221 (2004).
⁶N. Sharma, et al. J. Power Sources 195, 8258 (2010).
⁷A. Senyshyn, et al., J. Power Sources 203, 126 (2012).
⁸Xun-Li Wang, et al. Scientific Reports 2, 1 (2012).
⁹J. M. Sharaf, Appli. Rad. Isotope 54, 801 (2001).
¹⁰G. Harding and E. Harding, Appl. Rad. Isotope 68, 993 (2010).
¹¹R. S. Holt, et al., Nucl. Instr. Math. 221, 98 (1984).
¹²M. Itou, et al., in preparation.
¹³M. J. Cooper, et al., X-ray Compton Scattering (Oxford Univ. Press, Oxford, 2004) p. 31-39; p. 134-139.
¹⁴I. G. Kaplan, et al., Phys. Rev. B 68, 2351041 (2003).
¹⁵R. Ribberfors, Phys. Rev. B 12, 2067 (1975).
¹⁶B. Barbiellini, J. Phys. Chem. Solids 61 341 (2000).
¹⁷B. Barbiellini and A. Bansil, J. Phys. Chem. Solids 62 2181 (2001).
¹⁸A. Koizumi, et al. Phys. Rev. Lett. 86, 5589 (2001).
¹⁹H. Sakurai, et al., Appl. Phys. Lett. 88, 062507 (2006).
²⁰M. Ota, et al., Appl. Phys. Lett. 93, 116801 (2010).
²¹Y. Sakurai, et al., Science 332, 698 (2011).
²²N. Hiraoka, et al., J. Synchrotron Rad. 8, 26 (2001).
²³M. Itou, et al., Nucl. Instrum. Methods Phys. Res. A 467-468, 1109 (2001).
²⁴F. Biggs, et al. Atomic data and nuclear data tables 16, 201 (1975).
²⁵A. Bansil, et al., J. Phys. Chem. Solids 62, 2191 (2001).
²⁶A. Bansil, et al., Phys. Rev. B 60, 13 396 (1999).

### Determining Li Concentration Using Compton Scattering

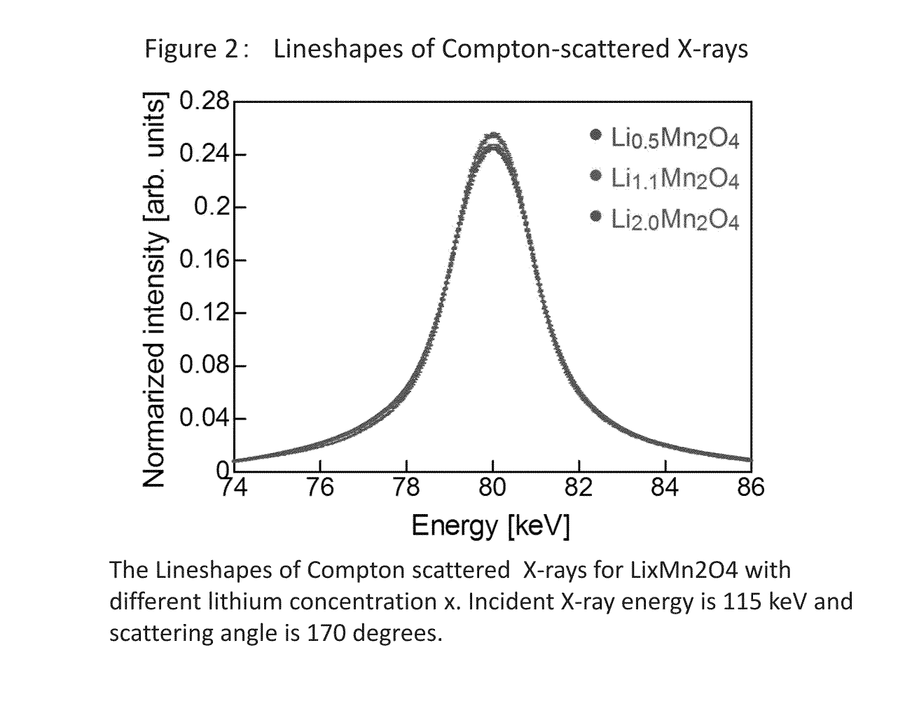

Disclosed are a method and apparatus for evaluating nondestructively the lithium concentration in electrodes of lithium ion batteries under in-situ and operando conditions by analyzing the energy spectra, hereafter the lineshape, of Compton scattered X-rays. A schematic drawing of the apparatus is in FIG. 1, and an example of the lineshape of Compton scattered X-rays is in FIG. 2.

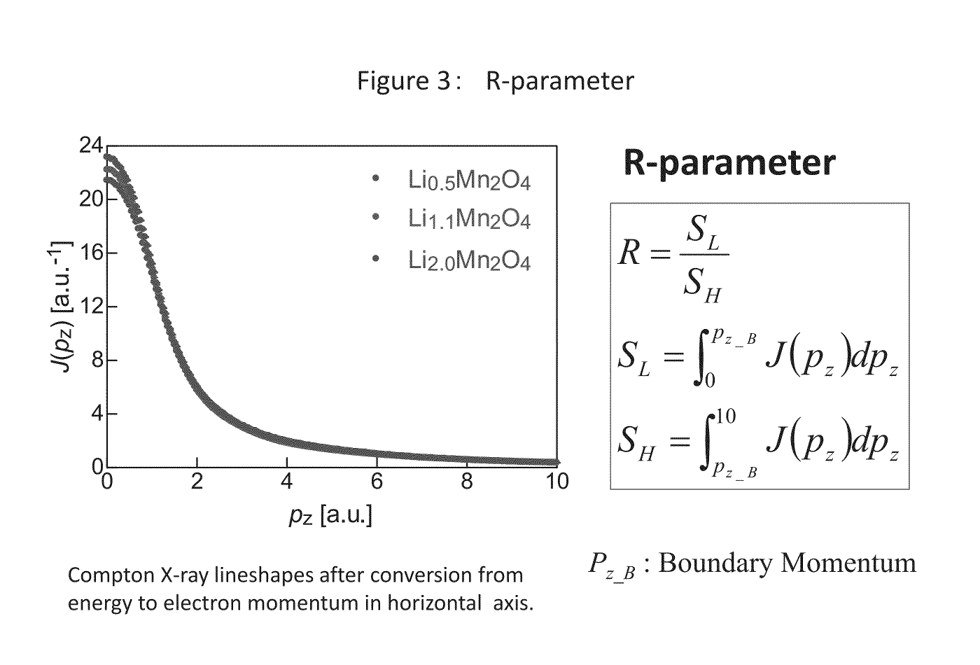

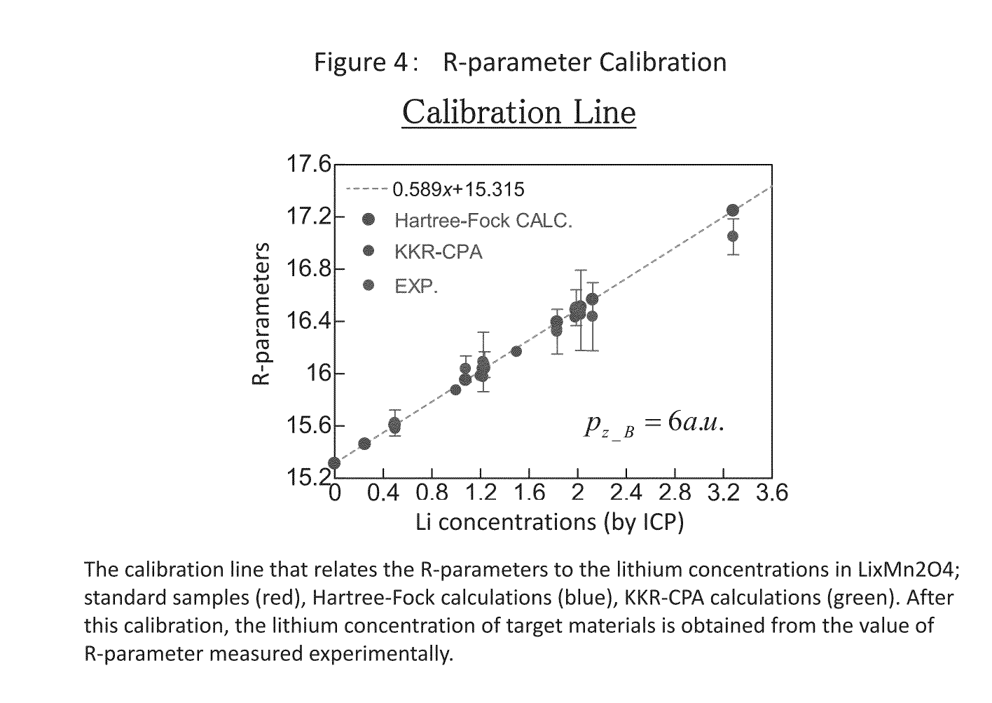

For the method of analyzing the lineshape (see FIG. 3), the energy scale of Compton scattered X-rays is converted to the momentum scale of electrons in materials. The lineshape is divided into two parts by a boundary point in momentum, hereafter boundary momentum, and the two areas under the lineshape which are defined below and above the boundary momentum respectively are evaluated. Then, the ratio between the two areas, hereafter called R-parameter, is evaluated. The boundary momentum may be determined by a number of methods. In some cases, the boundary momentum may be determined with the help of theoretical calculations so that the R-parameter is proportional to the lithium concentration in materials. The calibration line may be obtained with the help of measurements on a standard sample, in which Li concentration is known already, and/or the help of theoretical calculations (see FIG. 4). The calibration line may relate the experimentally measured R-parameters to the lithium concentration in the target materials.

In some cases, a value of the boundary momentum may be selected in the range between 2 atomic units and 8 atomic units, depending on a target material. In some cases, the boundary momentum may be determined by theoretical calculations and/or measurement(s) of standard sample(s), i.e. samples with a known composition, including a known Li concentration (see e.g. FIG. 6). The method and apparatus may be employed to probe the inside of a container, such as a battery, using, for example, incident X-rays lower than 1.022 MeV.

The apparatus may include a monochromator, a set of slits or a collimator to define the size of incident X-rays, a set of slits or a collimator for scattered X-rays, a sample positioning stage, and an X-ray detector. The method and apparatus may measure quantitatively the lithium concentration in the probing volume inside the targeted container, such as a battery. ICP (Inductively Coupled Plasma), X-ray diffraction, Auger electron spectroscopy, laser spectroscopy and X-ray Compton scattering were used for evaluating lithium concentration in electrode materials. However, ICP is a destructive technique, and Auger electron spectroscopy and laser spectroscopy are surface sensitive techniques. X-ray diffraction can probe the inside of the container and then evaluate the lithium concentration from X-ray diffraction peak positions. Because of its inherent variation in scattering angle for angle scanning mode or its poor resolution in X-ray energy for energy dispersive mode, however, X-ray diffraction is difficult to monitor the lithium concentration in a well-defined volume in a battery. On the other, X-ray Compton scattering with the use of high energy X-rays may be used to probe the inside of batteries.

The former approach in X-ray Compton scattering techniques was to measure the intensity of Compton scattered X-rays from a probing volume in a target sample. The intensity of Compton scattered X-rays may be equivalent to the area under the entire lineshape divided by the measurement time. A disadvantage of this intensity-measurement technique may be that the overall measured intensity is sensitive to the attenuation of both incident and scattered X-rays in the target sample, as well as the lithium concentration in a probing volume in the sample. This means that the lithium concentration cannot be evaluated from the intensity of Compton scattered X-rays. The influence of both X-ray attenuations is enhanced as the target sample becomes large. In practice, the intensity-measurement is not a suitable technique for large devices, such as large batteries, such as those mounted on electric vehicles.

The present invention may solve the above-mentioned problem in the former approach, which arises from X-ray attenuations in the target sample. The proposed novel and unusual approach may employ R-parameter mentioned above. R-parameter is independent of X-ray attenuations in the target sample and is proportional to the lithium concentration in materials. After calibrating the R-parameter with standard samples, the lithium concentration in a certain probing volume in a battery may be evaluated from the value of measured R-parameters.

One advantage of the present invention over the intensity-measurement X-ray/gamma-ray Compton scattering technique and other methods may be its ability for the direct measurement of lithium concentration under in-situ and/or operando conditions. Another advantage may be its applicability to large commercial batteries such as those mounted on plug-in hybrid electric vehicles or electric vehicles which is inaccessible to the other techniques and methods.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety.

What is claimed is:

1. A method of determining an elemental concentration, comprising
(a) obtaining a sample comprising a chemical element;
(b) measuring a Compton scattering spectrum of the sample; and
(c) analyzing a lineshape of the measured spectrum to determine a concentration of the element in the sample.

2. The method of claim 1, wherein the element is a metal element.

3. The method of claim 2, wherein the metal element is an alkali metal or an alkaline earth metal.

4. The method of claim 3, wherein the metal element is Li.

5. The method of claim 4, wherein the sample comprises a lithiated transition metal oxide.

6. The method of claim 4, wherein the sample comprises at least one of LiₓMn₂O₄; LiₓCoO₂; LiₓMnO₂; LiₓPO₄; LiₓNiO₂; LiₓTi₅O₁₂; LiₓFeSiO₄; LiₓNiₐCo_{b}Al_{c}O₂ and LiₓNiₐMn_{b}Co_{c}O₂ and said analyzing determines x, wherein each of a, b and c is a non-negative number, such that a+b+c=1.

7. The method of claim 1, wherein the sample is a solid sample.

8. The method of claim 7, wherein the sample is a polycrystalline sample.

9. The method of claim 1, wherein the sample is a liquid sample.

10. The method of claim 1, wherein the sample comprises a graphite intercalation compound or a silicon compound.

11. The method of claim 1, wherein said analyzing comprises determining a central-to-tail parameter in the measured spectrum and determining the concentration of the element from the determined the central-to-tail parameter.

12. The method of claim 11, wherein said determining the concentration comprises using a calibration curve establishing a relationship between the concentration of the element and the central-to-tail parameter in the measured spectrum.

13. The method of claim 12, further comprising obtaining the calibration curve, wherein said obtaining comprises measuring a Compton scattering spectrum of one or more calibrating samples having a known concentration of the element and determining a central-to tail-parameter in the Compton scattering spectrum of the one or more calibrating samples.

14. The method of claim 1, wherein said analyzing comprises presenting the measured spectrum as a Compton profile with an intensity in inverse atomic units versus a momentum in atomic units.

15. The method of claim 14, wherein said analyzing further comprises determining a ratio between a central area under the Compton profile to a tail area under the Compton profile.

16. The method of claim 15, wherein the central area is an area under the normalized Compton profile for values of the momentum ranging from 0 to a boundary value and the tail area is an area under the Compton profile for values of the momentum ranging from the boundary value to infinity, wherein said boundary momentum is between 2 atomic units and 8 atomic units.

17. The method of claim 1, wherein said measuring uses incident X-rays with energy greater than 50 keV and lower than 1.022 MeV.

18. The method of claim 1, wherein the obtained sample is inside a container, which is non-penetrable by photoelectrons and wherein said measurement is performed while the sample is inside the container.

19. The method of claim 18, wherein the sample is a part of an electronic device.

20. The method of claim 19, wherein the electronic device is a battery.
